(19) United States
(12) Patent Application Publication
(10) Pub. No.: US 2006/0119172 A1
(43) Pub. Date: Jun. 8, 2006

(54) Device for mounting a wheel to the frame of a bicycle

(75) Inventors: Jean-Pierre Mercat, Chavanod (FR); Jean-Marc Hillairet, Nevers (FR)

Correspondence Address: GREENBLUM & BERNSTEIN, P.L.C., 1950 ROLAND CLARKE PLACE, RESTON, VA, 20191, US

(73) Assignee: SALOMON S.A., Metz-Tessy (FR)

(21) Appl. No.: 11/286,353

(22) Filed: Nov. 25, 2005

Related U.S. Application Data
(63) Continuation of application No. PCT/FR04/01311, filed on May 27, 2004.

(30) Foreign Application Priority Data
May 28, 2003 (FR) 03.06546

(51) Int. Cl. B60B 27/00

(52) U.S. Cl. 301/105.1

(57) ABSTRACT

A device for mounting a wheel of a bicycle onto a frame, including an inner hub rotatably mounted on the frame and equipped with an inner axial support area, an outer hub connected to the rim of the wheel by means of traction spokes, compression spokes, or flanges, and including an outer axial support area that cooperates with the inner axial support area, a mechanism for tightening the outer hub on the inner hub, the inner and outer axial support areas being located at a distance from the axis of the wheel at least greater than 20 mm, or greater than 25 mm, and distributed along the vicinity of a circle having a radius greater than 25 mm, centered on the axis of the wheel. The inner and outer axial support areas include a plurality of teeth forming part of a transmission mechanism.

### CROSS-REFERENCE TO RELATED APPLICATIONS

This application is a continuation of PCT International Patent Application No. PCT/FR2004/001311, filed on May 27, 2004, the disclosure of which is hereby incorporated by reference thereto in its entirety, and the priority of which is claimed under 35 U.S.C. §120, pursuant to the provisions of 35 U.S.C. §363.

This application claims priority under 35 U.S.C. §119 of French Patent Application No. 03.06546, filed on May 28, 2003, the disclosure of which is hereby incorporated by reference thereto in its entirety.

### BACKGROUND OF THE INVENTION

1. Field of the Invention

The invention relates to a device for mounting a bicycle wheel to a frame with a quick-tightening mechanism, and a bicycle that includes such device. More particularly, the invention relates to such a device for mounting and demounting a bicycle wheel with a quick-tightening mechanism and, more particularly, for bicycles having frames with a projecting single arm, rather than a fork, the wheel hub being cantilevered from the single arm.

2. Description of Background and Relevant Information

In a single-arm wheel mounting device, a portion of the elements and functions typically found on the hub of a conventional wheel can advantageously remain permanently on the frame of a bicycle and not require removal or manipulation when a wheel is mounted or demounted from the frame. These elements include an inner hub that is rotatably mounted on the frame by means of a rolling bearing, which bears the chain sprockets and possibly a brake disk, on the one hand, and an outer hub, which is specific to the wheel and groups the traction spokes, the compression spokes or the sides of the latter, on the other hand. The connection between the outer and inner hubs must be easily separable as well as provide for a good transmission of forces. Among the forces that must be transmitted between the outer and inner hubs are the chain torque, the braking torque when braking is carried out by a disk and the disk is fixed on the inner hub, the radial and lateral forces exerted on the wheel when the wheel is not completely vertical. This is the case when the cyclist rides standing up on the pedals, or in a turn. It is estimated that the force exerted laterally with respect to the plane of the wheel, in the area of its contact with the ground, can reach 300 Newtons (N). The connection between the outer and inner hubs must also transmit a radial force oriented in the plane of the wheel; it is estimated that this force can reach 5000 N.

French Patent Publication No. 2 684 063 discloses a device of the aforementioned type, in which an inner hub is rotatably mounted in a bore of the frame, and on which the wheel is fixed. The hub has a reduced diameter and in order to ensure that the connection will resist the various forces to which the wheel is subjected, particularly the lateral forces, the connection is made with a threaded nut. Such a connection consequently necessitates the use of a tool in order to be accomplished. In addition, when the wheel is demounted, the hub has a substantial length that projects and risks being damaged during handling or when the bicycle is stored without a wheel.

European Patent Publication No. 1 153 827 discloses a single-arm wheel mounting device, which also includes an inner hub rotatably mounted on the bicycle frame and against which the wheel is fixed. The zone for supporting the wheel hub, i.e., the outer hub, against the inner hub is in the general shape of a cone. Although such a surface allows combining the centering of the wheel and the transmission of the lateral forces to which the wheel is subjected, it presents numerous drawbacks. First, it has a substantial axial space requirement in the area of the hub. It can also be a cause for inaccurate axial positioning of the median plane of the wheel. Another drawback of the device disclosed in EP 1 153 827 is that one has to make an accurate angular positioning of the wheel before being able to actuate the tightening mechanism, due to the presence of three pins provided for transmitting the driving torque of the chain. Finally, a major drawback of this type of construction lies in the clearance between the pins and the housings in which they are lodged. This functional clearance, to allow for the insertion and extraction of the wheel, generates an angular clearance of the wheel connection relative to the inner hub. Each successive acceleration or braking respectively positions the wheel at each end of this angular clearance.

### SUMMARY OF THE INVENTION

An object of the invention is to overcome the aforementioned drawbacks and in particular to provide for a device for mounting a wheel on a frame having a cantilevered arm, and for demounting a wheel therefrom, hereafter referred to as a mounting device, which can be used with a quick-tightening mechanism, sometimes referred to as a quick-release mechanism, and which is compact in the axial direction.

Another object of the invention is to provide a wheel mounting device in which the mounting of a wheel is simplified for a non-professional user and which does not require angular pre-positioning.

Another object of the invention is to provide a wheel mounting device which reduces the angular clearance.

Another object of the invention is to provide a mounting device which ensures an accurate axial positioning of the median plane of the wheel.

The invention achieves the aforementioned objects by the provision of a device for mounting a bicycle wheel onto a frame, including:
an inner hub rotatably mounted on the frame and equipped with an inner axial support zone;
an outer hub connected to the rim of the wheel by means of traction spokes, compression spokes, or flanges, and including an outer axial support zone that cooperates with the inner force transmission zone;
a mechanism for tightening the outer hub on the inner hub;
the inner and outer zones of axial support located at a distance of at least greater than 20 millimeters (mm) from the axis or, in a particular embodiment, greater than 25 mm from the axis.

Due to the spacing of the inner and outer zones of axial support zones by a distance greater than 20 mm, or greater than 25 mm, for the same tightening torque, the risk of the wheel being separated when subjected to a lateral force is reduced.

In a particular embodiment of the invention, the axial support zones are distributed in the vicinity of a circle having a radius greater than 25 mm. The axial space requirement is minimal.

In a particular embodiment of the invention, the inner support zone is arranged at the periphery of a pan-shaped plate.

In a particular embodiment of the invention, the inner and outer support zones include a plurality of teeth, which provide a mechanism for transmitting the chain driving torque and the braking torque.

### BRIEF DESCRIPTION OF THE DRAWINGS

The invention includes additional characteristics which will become apparent from the description that follows. This description describes several embodiments of the invention by way of example, with reference to the annexed drawings in which:

FIG. 1 is a schematic functional diagram of a first embodiment of the invention;

FIG. 2 is a cross-sectional view of the device according to the invention;

FIG. 3 is a front view of the inner hub of the device illustrated in FIG. 1;

FIG. 4 is a cross-sectional view of a device according to a second embodiment of the invention;

FIG. 5 is a perspective view of the crown and of the outer axial support zone.

### DETAILED DESCRIPTION OF THE INVENTION

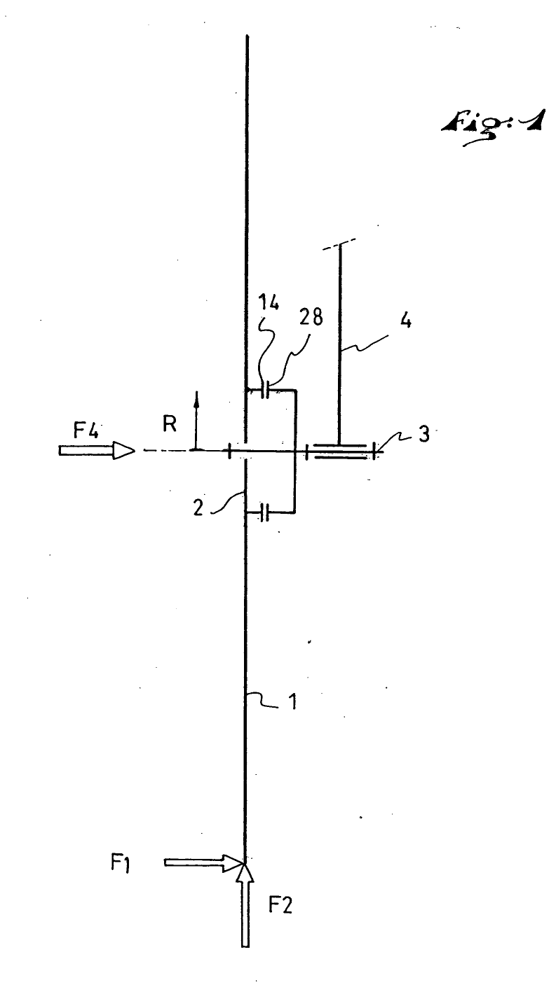

FIG. 1 shows a schematic functional diagram of a device for mounting a wheel 1 to a frame 4 according to the invention. An inner hub 3 is rotatably mounted relative to the frame 4. The inner hub 3 includes axial support areas distributed in the vicinity of a circle having a radius R. An outer hub 2 of the wheel 1 includes outer axial support areas 14 corresponding to the axial support areas 28 of the inner hub 3. The axial support areas 28 of the inner hub 3 are also distributed in the vicinity of a circle having a radius R. A centering arrangement ensures accurate positioning of the wheel on the inner hub 3. The diagram of FIG. 1 does not take into account the presence of transmission elements, transmitting the chain torque of the inner hub to the wheel. The diagram of FIG. 1 also does not show the chain torque, nor the torque to which the wheel is subjected during braking.

Generally speaking, the periphery of the wheel 1 could be subjected to a lateral force estimated at approximately 300 N. This force, represented in FIG. 1 by the arrow F1, can occur for example when taking a turn at high speed. Such a force has a tendency to separate the wheel from the mounting device, especially in view of the axial characteristics of the supporting areas 14, 28. The force F2, corresponding to the radial force applied to the wheel, can be substantially stronger and reach 5000 N. The wheel is kept in position by applying in the area of the inner hub a tightening force F4 oriented along its axis. In order to avoid any separation of the wheel, the radius R is chosen to be greater than 20 mm or greater than 25 mm.

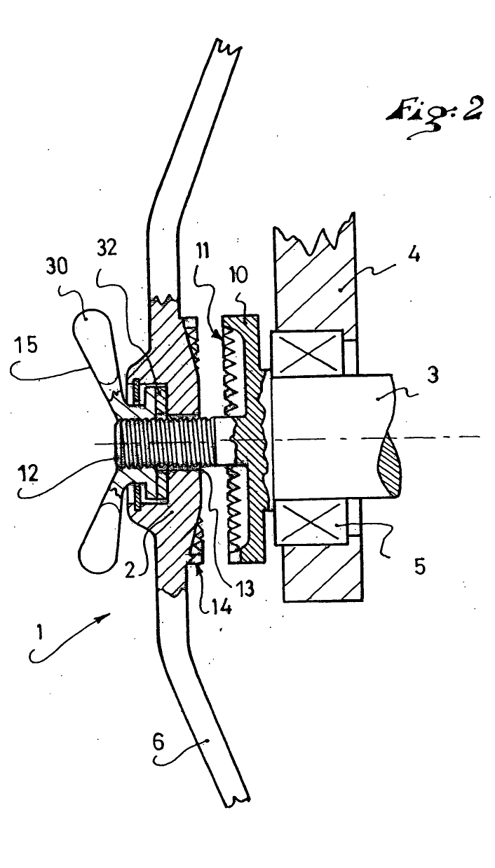

FIG. 2 shows a partial cross-section of a mounting device according to the invention. The inner hub 3 includes a cylindrical body rotatably mounted in a bore of the frame 4 by means of a ball or rolling bearing 5. One of the ends of this rotatable body is used to support the sprockets of the transmission chain. The other end is formed as an enlarged plate 10. A projecting flange equipped with a plurality of teeth 11 is arranged at the periphery of the plate 10, whereas at its center, a connection element 12 extends the cylindrical body of the hub 3. The connection element 12 in FIG. 2 is a threaded rod. The inner hub 3 can also be equipped with a brake disk (not shown).

The wheel 1 is of the spoked-wheel type, which means that the outer hub 2 and the rim are connected to one another by a plurality of compression spokes 6. As an example, the wheel can be constructed like that disclosed in the commonly owned U.S. patent application No. (Attorney Docket No. P28804), the disclosure of which is hereby incorporated by reference thereto in its entirety, and family member PCT International Publication No. WO 2004/108515. This is not to be considered limiting to the invention, and the mounting device according to the invention can be used with any type of wheel. The central zone of the wheel, hereafter referred to as the outer hub 2, includes an opening 13 centered on the axis and adapted to allow the previously mentioned connection element 12 (threaded rod) to pass through. Additionally, this opening 13 allows for pre-centering the wheel before it is fixed. The outer hub 2 also includes an outer axial support 14 for the axial support of the wheel on the inner hub 3. The outer axial support is arranged around a circle, the radius R of which, in the illustrated embodiment, is equal to or substantially equal to 25 mm, and includes a plurality of teeth adapted to be nested between the teeth 11 of the flange 10 of the inner hub 3. The nesting of the teeth not only ensures the positioning of the means for support and transmission of the lateral forces to which the wheel is subjected to the inner hub, and therefore to the frame, but also the transmission of the chain torque, from the inner hub to the wheel, as well as of the braking torque.

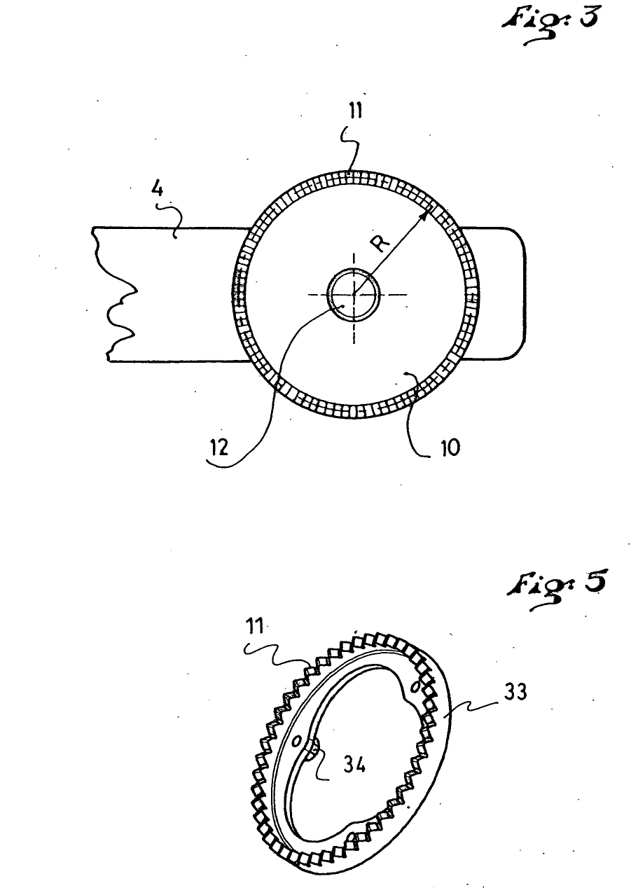

FIG. 3 shows a front view of the inner hub 3 and of the arm of the frame 4 before the wheel is mounted. The plurality of teeth 11 are arranged radially about the axis and continuously over the entire periphery. In the illustrated embodiment, for example, there are no gaps between the bases of respective ones of the teeth, the teeth being shown as having a pointed shape. The mounting of the wheel, in view of the continuous arrangement, is not limited to a few number of angular positions, but rather a significantly larger plurality of positions are possible, as many positions as there are teeth. Alternatively, it is contemplated that a continuous arrangement of the teeth on the inner hub can be chosen, with a discontinuous arrangement on the outer hub. In practice, the device according to the invention is very simple to use because the user can present the wheel in any angular position; the wheel is always ready to be received in the inner hub.

In a particular embodiment shown, with the teeth having a pointed shape, means the teeth are not flat at their tips. Although an embodiment in which the tips of the teeth are flat is possible, the non-flat tips prevent the tips of the teeth from remaining in support on one another, without nesting with one another, when the outer hub comes in contact with the inner hub. The ridges of the teeth are radial relative to the axis of the wheel. The radial characteristic of the ridges of the teeth is not limiting and one can provide a plurality of teeth, the ridge of which forms a constant angle with the spoke. In addition to the previously described functions, the nesting of the teeth ensures the centering of the wheel. Generally, the device according to the invention allows for a simple, fast mounting of the wheel while providing accurate positioning in both axial and radial directions.

The tightening device includes a wing nut retained inside a housing of the outer hub 2 by means of a circlip (elastic ring). To facilitate the tightening and to increase the available force, a skid-washer 32 is inserted between the base of the wing nut 15 and the outer hub. This skid-washer can be made out of “Permaglide®”, for example, or other friction-reducing material. The use of such a washer can double the efficiency of the tightening device. The wing nut further includes two wings 30 so as to enable tightening without a tool. The use of a wing nut is not limiting, and it can be replaced with any other tightening device, such as manual or quick-tightening devices in particular. Alternatively, in the context of the invention, the threaded rod 12 can also provided to extend, not from the inner hub but rather from the outer hub, and to be screwed into a threaded bore provided inside the inner hub.

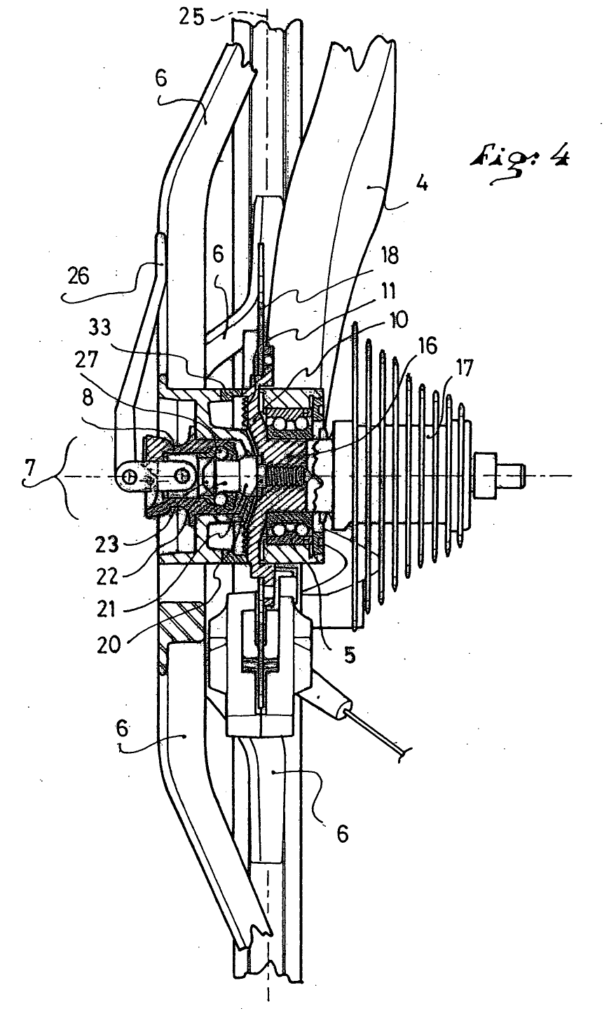

FIG. 4 illustrates a second embodiment of the invention. The rear arm of the frame 4 has a bore in which the inner hub 3 is rotatably mounted by means of ball bearing 5. The inner hub 3 includes a cylindrical body 16, the outer diameter of which is equal to the inner diameter of the ball bearing race 5. The free wheel body and the transmission chain sprockets are fixed to one of the ends of this cylindrical body. At the other end, the cylindrical body widens to become a plate 10. This plate 10 includes means for connecting a brake disk 18 and a plurality of teeth 11 uniformly distributed around a circle and projecting in a direction parallel to the axis of rotation. The height of the teeth ranges between 1 and 5 mm and their width between 1 and 2 mm. The apex angle ranges between 15° and 20°. These values are not limiting in the context of the invention.

In all, the volume devoted to the transfer of the axial forces, to the transmission of the chain torque and to the centering of the wheel on the inner hub is limited to an annular volume, the outer shape of which is a circle having a radius R substantially equal to 30 mm and having a thickness corresponding to the height and width of the teeth. Due to this minimal axial space requirement, a larger space can be allotted to other functions such as, for example, the quick-tightening/release mechanism.

A pin 20 is fixed at the center of the plate. This pin 20 includes a threaded point screwed into the cylindrical body of the hub, and a projecting portion including a base 21, a groove 22, and a beveled end-piece 23.

FIG. 4 also shows a wheel 1 fixed in a cantilevered manner by the mounting device according to the invention, rather than by being fixed between the forks of a conventional frame. The wheel 1 is a so-called compression-spoke wheel. Four of the compression spokes of this wheel are shown in FIG. 4. The compression spokes 6 connect the rim 24 to the central portion of the wheel, i.e., to the outer hub. The wheel 1 can be manufactured by molding a light alloy or a thermoplastic material. This technology allows for greater freedom in forming the shape of the compression spokes. Unlike traction spokes, compression spokes are not necessarily straight. In the example shown, the curved shape of the compression spokes allows for off-centering and re-centering the median plane 25 of the wheel. The center of the wheel, i.e., the outer hub, includes a recess in which the quick-tightening mechanism 7 is housed. The quick-tightening mechanism includes a cover 8 fixed on the outer hub. The top of the cover includes an opening through which a connecting-rod extends. Inside the cover slides a ball cage 9, the latter being retained inside the cover 8 by means of the connecting-rod to which it is fixed by a pin/axle. A lever 26 is rotatably mounted on a pin/axle retained on the top of the cover 8. The lever 26 and the connecting rod 31 are also pivotally mounted with respect to one another about an axis that is off-centered relative to the axis of rotation of the lever 26. Thus the rotation of the lever 26 generates the translational movement of the ball cage 9 within the cover 8, by means of a knuckle-joint mechanism, or over-center mechanism, constituted by the connecting rod and the lever. The cage includes a plurality of cells distributed in its cylindrical wall. On the inner surface face of the cage, the cells have a slightly smaller diameter than that of the balls 27 so as to prevent them from coming out from the inside of the cage. On the outer face of the cage 9, the balls 27 are retained inside the cells by the cover 8. When the quick-tightening mechanism is in an open position, the lever is oriented substantially along the axis and the ball cage is in its farthest position away from the lever. In this position, the inner surface of the cover provides the balls with the possibility to move away from the center. When the wheel is positioned in front of the inner hub, taking care to insert the pin 20 inside the quick-tightening mechanism 7, the beveled end of the latter drives the balls outward, enabling the pin to be entirely inserted. At the end of the insertion, the teeth of the inner and outer support zones then come in contact. The pivoting of the lever 26 towards the folded position, that is, in a position parallel to one of the compression spokes, has the effect, via the connecting-rod, of pulling the ball cage towards it. In this position, the balls 27 in each of the cells are forced inward by the inner surface of the cover which shrinks. The pin 20 is then confined in the ball cage 9 and the translational movement of the cage 9 results in more strongly pressing the outer support zone against the inner support zone. Due to the arrangement of the inner and outer support zones along a circle having a radius greater than 20 mm, or greater than 25 mm, the central space can be entirely occupied by the wheel quick-tightening device.

The demounting of the wheel is undertaken symmetrically: the lever is moved from the folded position when actuated by the user. Thus the ball cage is pushed towards the inner hub, providing the balls with the possibility to move away from their central position. The balls are indeed driven away by the edges of the groove provided on the pin when the user applies traction on the wheel to demount it.

The teeth located on the inner hub are made by machining the periphery of the plate. The teeth located on the outer hub can also be directly machined therefrom. In the embodiment shown in FIG. 4, a crown 33 is made by metallic powder sintering and is then joined to the outer hub.

The crown 33 is shown in perspective in FIG. 5. It includes a flat zone that is supported on the outer hub. Three lugs 34 extending from this flat zone and projecting therefrom are provided to fit into three bores arranged in the outer hub 2. Because the lugs are threaded, a screw retains the crown 33 to the outer hub 2. To eliminate any angular clearance, the lugs 34 are tightly adjusted in the corresponding bores. Alternatively, a molded material, such as Zarmac®, for example, can replace the sintered material.

Although the invention has been described with reference to preferred embodiments, other embodiments including modifications thereof can also be envisioned according to the invention.

### LIST OF ELEMENTS

1-wheel

2-outer hub

3-inner hub

4-frame

5-rolling bearing

6-compression spoke

7-tightening mechanism

8-cover

9-cage

10-plate

11-tooth

12-connection element

13-opening

14-outer axial support

15-wing nut

16-cylindrical body

17-free-wheel body

18-brake disk

19-axis of rotation

20-pin

21-base

22-groove

23-end piece

24-rim

25-median plane of the wheel

26-lever

27-ball

28-inner axial support

29-circlip (elastic ring)

30-wing

31-connecting rod

32-skid-washer

33-crown

34-lug

1. A device for mounting a bicycle wheel onto a bicycle frame, said device comprising:
an inner hub adapted to be rotatably mounted on the bicycle frame by means of at least one rolling bearing and equipped with an inner axial support zone;
an outer hub connected to a rim of said wheel by means of traction spokes, compression spokes, or flanges, and including an outer axial support zone that cooperates with said inner axial support zone;
a mechanism for tightening said outer hub to said inner hub;
said inner and outer axial support zones being positioned in the vicinity of a circle having a radius greater than 25 mm, centered on an axis of the wheel.

2. A device for mounting a bicycle wheel according to claim 1, wherein:
the inner hub includes a cylindrical body adapted to be rotatably mounted in a bore of the bicycle frame, said inner hub further comprising a plate, said plate having a periphery, said inner support area being arranged at said periphery of said plate.

3. A device for mounting a bicycle wheel according to claim 1, wherein:
each of said inner and outer axial support zones includes a plurality of teeth, said plurality of teeth comprising a part of a transmission mechanism of the bicycle.

4. A device for mounting a bicycle wheel according to claim 3, wherein:
said plurality of teeth of said outer support zone are made by a process comprising machining material of said inner hub.

5. A device for mounting a bicycle wheel according to claim 3, wherein:
said plurality of teeth of said outer support zone are made by a process comprising using sintered metallic powders.

6. A device for mounting a bicycle wheel according to claim 3, wherein:
said plurality of teeth of said outer support zone are made by a process comprising molding.

7. A device for mounting a bicycle wheel according to claim 3, wherein:
said plurality of teeth of at least one of said inner and outer support zones comprises a continuous series of teeth, said teeth having a height of ranging from 1 mm to 5 mm.

8. A device for mounting a bicycle wheel according to claim 1, wherein:
said tightening mechanism includes a threaded rod projecting from said inner hub and a wing nut positioned in a bore of the outer hub; and
a skid-washer is positioned between said wing nut and said inner hub.

9. A device for mounting a bicycle wheel according to claim 1, wherein:
said tightening mechanism comprises a quick-tightening mechanism, said quick-tightening mechanism comprising:
a pin projecting from the inner hub and equipped with a groove;
a cover fixed on the outer hub;
a ball cage slidably mounted inside of said outer hub;
a connecting rod and a pivotable lever associated with a cam for transforming a pivotal movement of the lever into a translational movement of the ball cage and the connecting rod.
